(19) United States
(12) Patent Application Publication
(10) Pub. No.: US 2009/0084470 A1
(43) Pub. Date: Apr. 2, 2009

(54) REDUCED-PRESSURE HEAT TREATMENT JIG AND REDUCED-PRESSURE HEAT TREATMENT METHOD

(75) Inventors: Susumu KATO, Anjo-shi (JP); Nozomu Shinkou, Anjo-shi (JP); Moriyuki Tabata, Anjo-shi (JP); Keita Taguchi, Anjo-shi (JP); Kazuaki Okada, Anjo-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN AW CO., LTD., Anjo-shi (JP)

(21) Appl. No.: 12/237,635

(22) Filed: Sep. 25, 2008

(30) Foreign Application Priority Data
Sep. 28, 2007 (JP) 2007-253191

(51) Int. Cl. F27D 5/00; C23C 8/22

(52) U.S. Cl. 148/225; 432/227; 148/223

(57) ABSTRACT

A reduced-pressure heat treatment jig is used for supporting a workpiece of iron when the workpiece is subjected to heat treatment in a reduced-pressure atmosphere in which pressure is reduced compared to atmospheric pressure. The jig is formed of an iron material and is formed with a film on at least a contact surface with the workpiece, the film being formed of a material which persists during the heat treatment. The film preferably includes a metal oxide having an evaporating temperature higher than the heat treatment temperature in the reduced-pressure atmosphere. The film preferably contains aluminum oxide.

### INCORPORATION BY REFERENCE

The disclosure of Japanese Patent Application No. 2007-253191 filed on Sep. 28, 2007 including the specification, drawings and abstract is incorporated herein by reference in its entirety.

### BACKGROUND OF THE INVENTION

1. Field of the Invention

The present invention relates to a heat treatment jig for supporting a workpiece when a heat treatment is performed under a reduced-pressure atmosphere, and a reduced-pressure heat treatment method using the same.

2. Description of the Related Art

There are cases where various materials formed of an iron material, for example steels such as carbon steel and special steel, are subjected to heat treatment under reduced pressure, for example a reduced-pressure carburization treatment. In these cases, a workpiece formed of the iron material is usually arranged in a heat-treating furnace in a state supported by a heat treatment jig rather than being placed directly in the furnace.

The heat treatment jig is often formed from iron materials, for example steels such as Nickel (Ni) steel, which have excellent heat resistance and durability.

Note that a reduced-pressure heat treatment is disclosed in Japanese Patent Application Publication No. JP-A-8-325701, for example.

When a heat treatment is performed on a workpiece formed of an iron material supported on a heat treatment jig formed of iron material, no large problem will occur between the workpiece and the heat treatment jig when the heat treatment is performed under normal atmospheric pressure.

However, when the heat treatment is performed in a reduced pressure atmosphere of compared to the atmospheric pressure, there has been a problem of adherence between the heat treatment jig and the workpiece supported by the heat treatment jig.

Even if the degree of adherence is small, a dimensional accuracy may be affected to cause a defective product in the case where an extremely high standard of dimensional accuracy is required for the workpiece, for example.

### SUMMARY OF THE INVENTION

In order to solve the problems described above, the present invention provides a reduced-pressure heat treatment jig which prevents the heat treatment jig and a workpiece from adhering to each other even in the case where a reduced-pressure heat treatment is performed. The present invention also provides a reduced-pressure heat treatment method using the reduced-pressure heat treatment jig.

A first aspect of the present invention is a reduced-pressure heat treatment jig used for supporting a workpiece of iron when the workpiece is subjected to heat treatment in a reduced-pressure atmosphere in which pressure is reduced compared to atmospheric pressure, the jig being formed of an iron material and being formed with a film on at least a surface in contact with the workpiece, the film being formed of a material which persists during the heat treatment.

The reduced-pressure heat treatment jig (hereinafter appropriately referred to as the “jig”) of the first aspect of the present invention is formed of the iron material as described above, and the film is formed on at least the surface thereof in contact with the workpiece. The film is a film formed of the material which persists without burning, evaporating, or the like during the heat treatment, i.e., while the temperature is increased and held at heat treatment temperature in the reduced-pressure atmosphere.

A jig surface and a workpiece formed of iron materials are usually formed with a film of iron oxide. As a result of a survey conducted by the inventors, it has been found that films of iron oxide easily evaporate in a high temperature, reduced pressure atmospheres. Since newly-formed surfaces of the iron materials are exposed where the iron oxide has evaporated, the jig and the workpiece are exposed to high temperature in a state where their newly-formed surfaces come into contact with each other. It is speculated that adherence between the jig and the workpiece is caused as a result.

The jig of the present aspect of the present invention is formed with a film formed of the material described above, and the film persists without evaporating or the like during the heat treatment. Therefore, the surface of the jig where the film is formed continues to be covered by the film without an appearance of the newly-formed surface of the iron material. Thus, the workpiece and the jig can be prevented from contacting each other on the newly-formed surfaces during heat treatment, whereby the adherence thereof can reliably be prevented.

Use of the jig can prevent deformation and the like due to the adherence and can contribute to an improvement in quality, even in the case of treating a workpiece which requires an extremely high standard of dimensional accuracy, for example.

As described above, the present aspect of the present invention provides a reduced-pressure heat treatment jig which prevents adherence between the heat treatment jig and a workpiece even in the case where a reduced-pressure heat treatment is performed.

A second aspect of the present invention is a reduced-pressure heat treatment method in which a workpiece formed of iron is supported by the reduced-pressure heat treatment jig according to the first aspect of the present invention when the workpiece is subjected to heat treatment in a reduced-pressure atmosphere in which pressure is reduced as compared to atmospheric pressure.

The reduced-pressure heat treatment method of the present aspect of the present invention is performed while supporting the workpiece with the jig described above. Therefore, as described above, adherence between the workpiece and the jig can reliably be prevented even if the heat treatment is performed under reduced pressure.

### BRIEF DESCRIPTION OF THE DRAWINGS

FIG. 1 is an illustrative view showing a structure of a reduced-pressure heat treatment jig of a first embodiment;

FIG. 2A is a plan view and FIG. 2B is a sectional view showing a structure of a workpiece (ring gear);

FIG. 3 is an illustrative view showing vapor pressure curves of metal oxides at high temperature and under reduced pressure in the first embodiment;

FIG. 4 is an illustrative view showing a structure of a reduced-pressure heat treatment jig of a second embodiment;

FIG. 5 is an illustrative view showing a BBD ellipse measurement result in the case where a reduced-pressure heat treatment jig of the present invention is used in a third embodiment; and

FIG. 6 is an illustrative view showing a BBD ellipse measurement result in the case where a reduced-pressure heat treatment jig of the related art is used in the third embodiment.

### DETAILED DESCRIPTION OF THE EXEMPLARY EMBODIMENTS

A reduced-pressure heat treatment jig of the present invention is formed using an iron material as described above. As the iron material, Ni steel or various other known heat-resistant steels may be used in the case where heat treatment temperature is extremely high. As the shape thereof, various shapes suitable for supporting a workpiece may be employed.

As a film, various materials may be used as long as the material stably persists without evaporating or the like in the case where the temperature is increased to heat treatment temperature in a reduced-pressure atmosphere.

It is particularly preferable that the film contain a metal oxide having an evaporating temperature higher than the heat treatment temperature in the reduced-pressure atmosphere. The metal oxide having the high evaporating temperature can stably exist during heat treatment and reliably provide the adherence prevention effect described above.

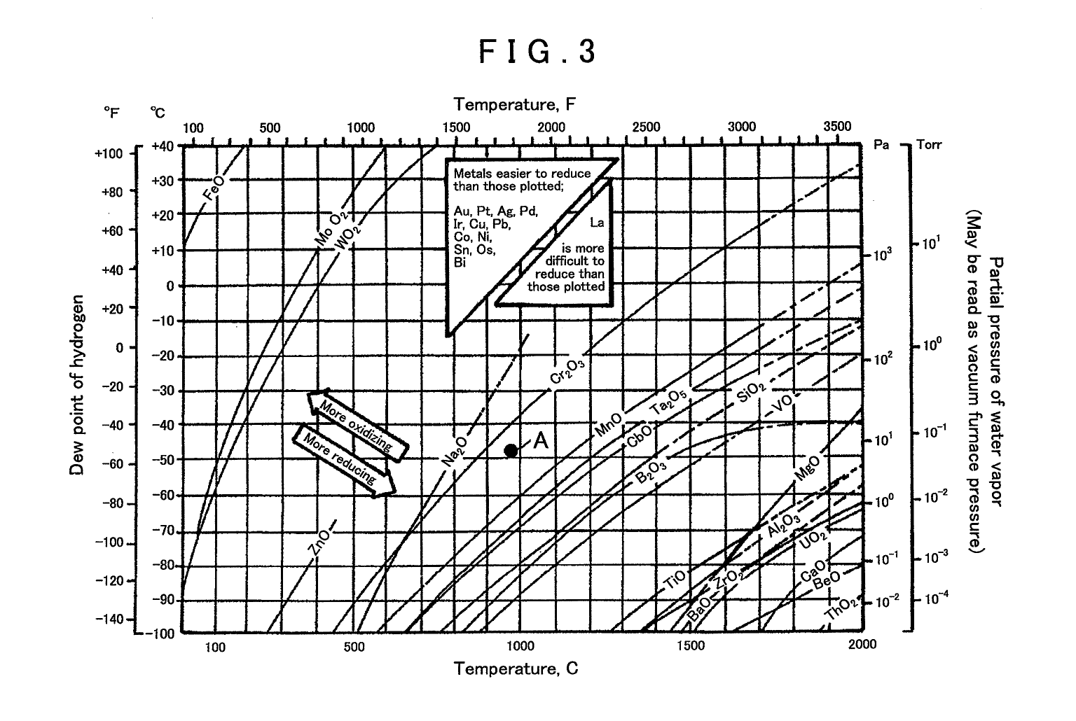

The film preferably contains aluminum oxide. As can be seen from FIG. 3 described later, aluminum oxide (Al₂O₃) has a higher evaporating temperature than iron oxide (FeO) in all pressure ranges shown in FIG. 3, and stably exists at typical heat treatment temperatures (950° C. or above). Since the cost is relatively low and handling is relatively easy, aluminum oxide is extremely effective as the material of the film.

The film can be formed by immersing the jig in a molten bath of metal comprising the metal component of the metal oxide so as to arrange the metal on the surface of the jig, and then at least one of leaving the metal in air and performing heating treatment so as to generate the metal oxide. In this case, the contact between the molten metal and the jig allows an adhesive arrangement of the metal with the jig surface and formation of a film having high adhesiveness. The advantageous effect of the molten metal permeating into the surface of the iron material of the jig to be alloyed can be obtained, and durability of the film can be improved. In the case where the metal is a material easily oxidized in air, e.g., aluminum, a stable metal oxide can be generated merely by leaving the metal in air.

The film can also be formed by applying at least one of coating material and slurry containing particles of the metal oxide to the surface of the jig. In this case, the film can be formed in a simple manner. The coating material or the slurry to be applied may be in various forms as long as at least particles of the metal oxide are contained. Various known methods may be used as an application method. It is also useful to perform heating and burning as necessary after the application.

In either case, a method of forming the film is not limited to the examples described above, and various alternative methods may be employed.

In terms of functionality, it suffices that the film be formed at on least the surface in contact with the workpiece as described above. However, there are cases where, for example, it is easier to form the film for an entire jig than to form the film partially. Thus, the film may be disposed on approximately the whole surface of the jig.

The heat treatment is preferably a reduced-pressure carburization treatment. The reduced-pressure carburization treatment is an extremely effective carburization treatment performed under reduced pressure as a surface reformulation method for a steel material. In the case of performing the reduced-pressure carburization treatment, there has been a problem that particularly the jig and the workpiece formed of iron materials easily adhere together. Therefore, it is extremely effective to prevent the adherence by using the jig in the reduced-pressure carburization treatment.

A reduced-pressure state of the heat treatment may be in a range of 0.001 to 0.1 bars. Since the reduced-pressure heat treatment is performed within this reduced pressure range in many cases, it is extremely effective to use the jig for the heat treatment performed under these atmospheric conditions.

The jig works particularly effectively in the case where the workpiece is a ring gear having an approximately cylinder-shaped ring section, in which spline teeth are formed on an outer circumference surface or an inner circumference surface of the ring section. The ring gear is a part which requires an extremely high standard of dimensional accuracy, and a slight deformation or degradation in dimensional accuracy caused by adherence poses a large problem. Thus, it is extremely effective to use the jig for the reduced-pressure heat treatment with respect to the ring gear.

### Embodiments

### First Embodiment

A reduced-pressure heat treatment jig and a reduced-pressure heat treatment method according to an embodiment of the present invention will be described with reference to the drawings.

In this embodiment, a method of heat-treating a ring gear as a workpiece 8 formed of carbon steel in a reduced-pressure atmosphere in which pressure is reduced compared to an atmospheric pressure is taken as an example, and a reduced-pressure heat treatment jig 1 (hereinafter appropriately referred to as the “jig 1”) used for the treatment will also be described.

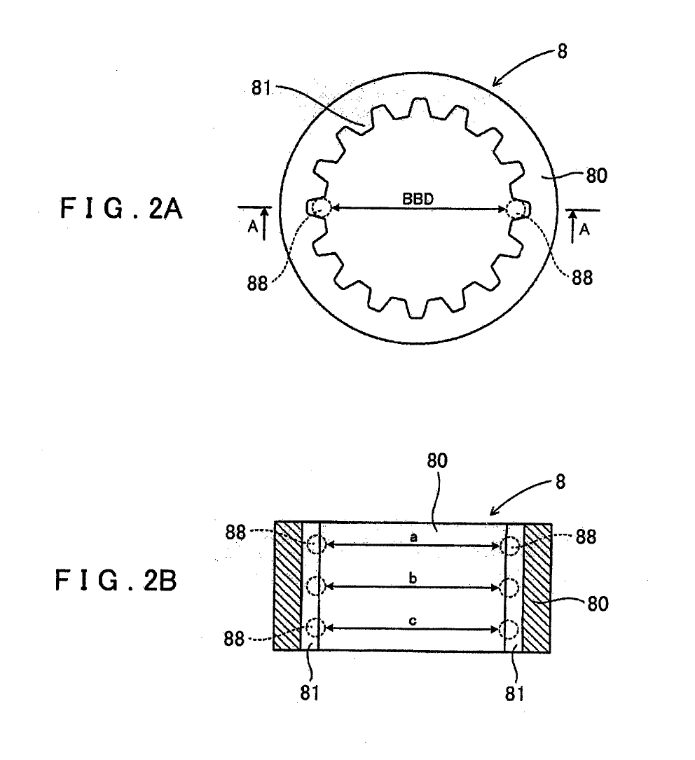

As shown in FIG. 2, the workpiece 8 of this embodiment is a ring gear having a cylinder-shaped ring section 80, in which spline teeth 81 are formed on an inner circumference surface of the ring section 80. The ring gear is a part incorporated in an automatic transmission (A/T) for an automobile, and is required to have an extremely high standard of dimensional accuracy, including for example roundness.

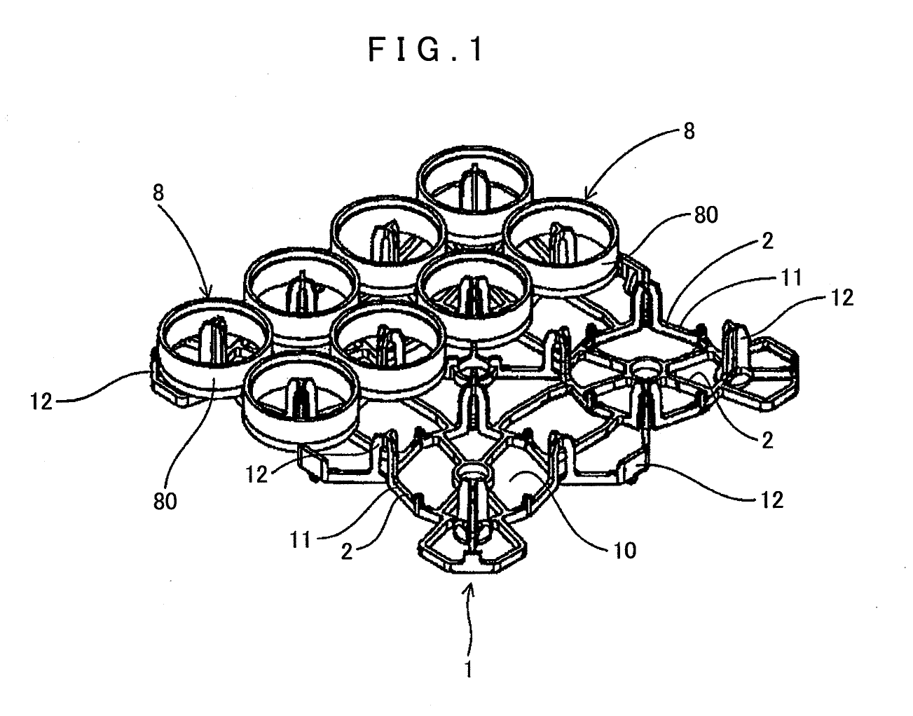

As shown in FIG. 1, the jig 1 supporting the workpiece 8 is a type of jig which supports the workpiece 8 with the workpiece's axis in a vertical direction. As shown in FIG. 1, the jig 1 has a skeletal structure in which skeletal sections 11 are provided to encompass a number of spaces 10, so that atmosphere gas for heat treatment can circulate. The jig 1 has a plurality of positioning protrusion sections 12, and is formed to be easily capable of determining a supporting position of each workpiece 8.

The jig 1 is formed to support the workpiece 8 in a state where an end surface of the ring section 80 of the workpiece 8 contacts an upper surface of each skeletal section 11.

An iron material, specifically, heat-resistant cast steel SCH13 is employed as a material of the jig 1. A film 2 which persists during the reduced-pressure heat treatment of this embodiment described later is formed on an upper surface of the skeletal section 11 of the jig 1.

The film 2 of this embodiment is a film containing aluminum oxide as the largest constituent, and is formed by an aluminum diffusion coating treatment method.

The reduced-pressure heat treatment performed in this embodiment is a reduced-pressure carburization treatment.

Specifically, acetylene for carburization is used as the atmosphere gas, the pressure thereof is reduced to 0.001 bars, and the carburization temperature is set to 950° C. and is slowly cooled after being held for a predetermined period of time in the treatment.

The reduced-pressure carburization treatment is performed in a state where the workpiece 8 is supported by the jig 1 having the film 2 on the surface, as shown in FIG. 1 described above.

Research was conducted by detaching the workpiece 8 from the jig 1 after the reduced-pressure carburization treatment to determine whether adherence had occurred therebetween. The results of this research showed no adherence.

Considering that the adherence would have occurred in the case where the same reduced-pressure carburization treatment as that described above is performed with a related-art jig that has no film 2, it can be seen that the use of the jig 1 of this embodiment is extremely effective.

The reason this advantageous effect can be obtained is speculated as follows.

FIG. 3 shows vapor pressure curves of metal oxides at high temperature and under reduced pressure. In FIG. 3, the heat treatment conditions of this embodiment, i.e., the condition point (A) of the degree of pressure reduction and the temperature, is plotted.

Referring to FIG. 3, it can be seen that iron oxide (FeO) evaporates and cannot exist stably whereas aluminum oxide (Al₂O₃) can stably exist as an oxide at least at this condition point. It is presumed that this phenomenon also occurs in an atmosphere of acetylene for carburization of this embodiment.

Thus, the surface of the jig 1 and the surface of the workpiece 8 would have become newly-formed surfaces without an iron oxide film during the reduced-pressure heat treatment in the related art, but the film 2 containing aluminum oxide continues to stably exist on the surface of the jig 1 in this embodiment. It is presumed that these differences are the cause of difference between adherence occurring and being prevented in the related art and the present embodiment, respectively.

### Second Embodiment

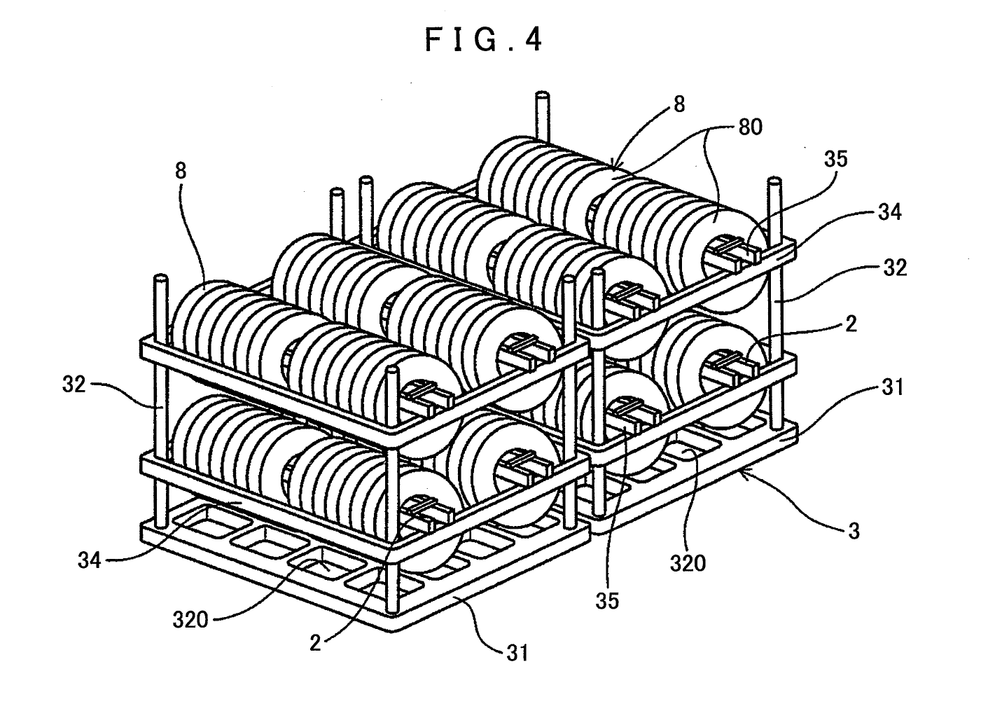

In this embodiment, a reduced-pressure heat treatment jig 3 (hereinafter appropriately referred to as the “jig 3”) is used instead of the jig 1 of the first embodiment as an example, as shown in FIG. 4. The workpiece 8 and the reduced-pressure carburization treatment are similar to those of the first embodiment.

As shown in FIG. 4, the jig 3 of this embodiment is a jig formed to support the workpiece 8 with the axis of the workpiece in a horizontal direction in a state such that the workpiece 8 is hung from a hang rack 35, which is a part of the jig 3. As shown in FIG. 4, a bottom plate section 31 of the jig 3 has a skeletal structure in which a number of spaces 320 are provided, so that atmosphere gas can circulate. At the bottom plate section 31, a plurality of pillar sections 32 are set, and it is formed such that the pillar sections 32 supports a side rack 34 and the hang rack 35.

The feature of this embodiment is that the film 2 similar to that of the first embodiment is formed on the surface of the hang rack 35.

There was no occurrence of adherence at a contact section between the hang rack 35 and the workpiece 8 when the reduced-pressure carburization treatment was performed using the jig 3 of this embodiment.

### Testing of Exemplary Embodiment 1

A test for measuring and evaluating a dimensional accuracy of the workpiece 8 after treatment was performed in order to clarify the advantage in the case where the reduced-pressure heat treatment is performed using the jig 1 described in the first embodiment.

Specifically, a jig of the related art with the same shape but without the film 2 was prepared separate from the jig 1, two charges of the same reduced-pressure carburization treatment as that of the first embodiment were performed, and heat treatment was performed for a total of 336 workpieces 8.

The evaluation of the dimensional accuracy was performed by a measurement of a so-called “BBD ellipse.” Specifically, as shown in FIGS. 2A and 2B, steel spheres 88 having a predetermined diameter are arranged to contact a concave portion of the spline teeth 81, and the “BBD” which is a dimension obtained by measuring an inner diameter dimension between the opposing steel spheres 88 is determined. The measurement is performed with respect to the whole circumference at three parts in the shaft direction (position a, position b, and position c in FIG. 2B), and an average value (Ave), a maximum value (Max), and a minimum value (Min) of the measurement values are determined.

Next, a difference between the maximum value and the minimum value of the “BBD” at each measurement position in the shaft direction was determined as “BBD ellipse (μm).”

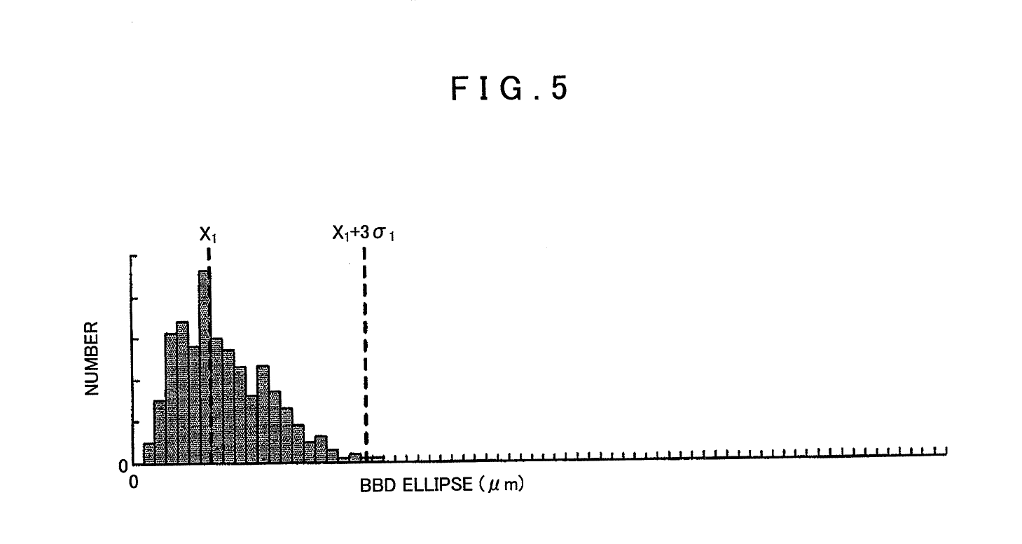

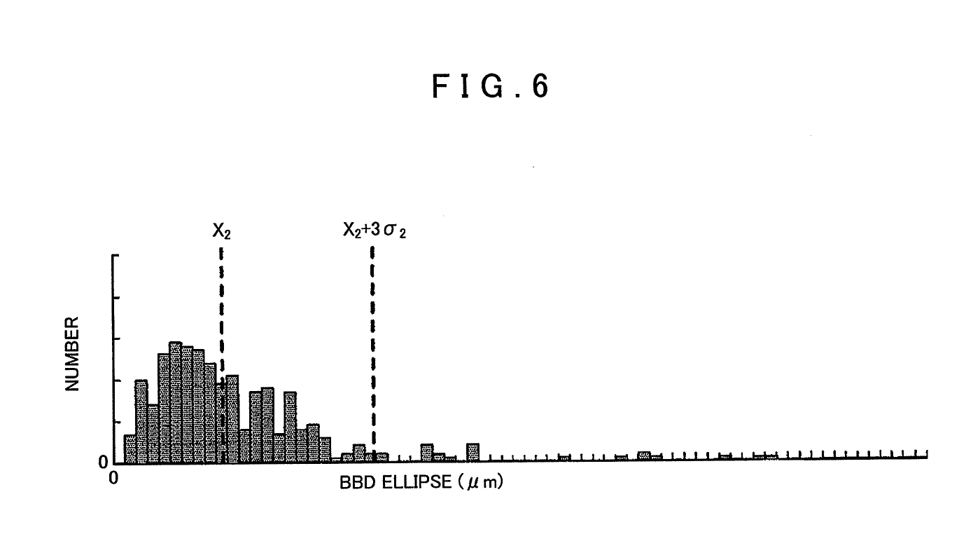

In this embodiment, the position b in the shaft direction (central section in the shaft direction) is taken as a representative example and is shown in FIGS. 5 and 6. FIG. 5 shows a result of the first embodiment of the present invention in which the reduced-pressure carburization treatment is performed using the jig 1 of the present invention shown in the first embodiment. FIG. 6 shows a result of a related-art example in which the reduced-pressure carburization treatment is performed using a jig of the related art having no such film. In FIGS. 5 and 6, the abscissa indicates values of the BBD ellipse (μm) and the ordinate indicates the number thereof.

As can be seen in FIG. 5, in the case where the jig 1 having the film 2 of the present invention is used, no BBD ellipse is sporadically affected in dimensional accuracy, and an average value (X₁) and a value calculated by adding the average value and 3σ (X₁+3σ₁) (σ: standard deviation) is considerably smaller than that of the related-art embodiment described later. In the exemplary embodiment of the present invention, there was no resistance in detaching the workpiece 8 from the jig 1, and there was no adherence.

On the other hand, as can be seen in FIG. 6, in the case where the jig of the related art having no film is used, the BBD ellipses were frequently affected in extremely large values. Those with sporadically affected BBD ellipses all showed resistance in detaching the workpiece 8 from the jig, and showed occurrence of adherence to some extent. Note that presence or absence of the adherence can be confirmed by measuring stress when the workpiece 8 is detached from the jig.

In the related-art example, an average value (X₂) and a value calculated by adding the average value and 3σ (X₂+3σ₂) (the values were calculated excluding a large outlier) were larger than those of the present invention. The differences of the average values and the values calculated by adding each average value and 3σ between the case of the present invention and the case of the related-art example are respectively X₂−X₁=12 μm and (X₂+3σ₂)−(X₁+3σ₁)=43 μm, which means that the BBD ellipse of the first embodiment is more advantageous based on these values.

As described above, according to this embodiment, it can be seen that performing the reduced-pressure carburization treatment using the jig 1 having the film 2 of the first embodiment is extremely effective in improving the quality of the ring gear (workpiece 8).

What is claimed is:

1. A reduced-pressure heat treatment jig formed of an iron material and used for supporting an iron workpiece when the workpiece is subjected to heat treatment in a reduced-pressure atmosphere in which pressure is reduced compared to atmospheric pressure, the reduced-pressure heat treatment jig, comprising:
a film formed on at least a surface in contact with the workpiece, the film being formed of a material which persists during the heat treatment.

2. The reduced-pressure heat treatment jig according to claim 1, wherein the film contains a metal oxide having an evaporating temperature higher than a temperature of the heat treatment in the reduced-pressure atmosphere.

3. The reduced-pressure heat treatment jig according to claim 2, wherein the film contains aluminum oxide.

4. The reduced-pressure heat treatment jig according to claim 2, wherein the film is formed by immersing the jig in a molten bath of metal comprising the metal component of the metal oxide, so as to arrange the metal on a surface of the jig, and then at least one of leaving the metal in air and performing heating treatment so as to generate the metal oxide.

5. The reduced-pressure heat treatment jig according to claim 2, wherein the film is formed by applying at least one of coating material and slurry containing particles of the metal oxide on a surface of the jig.

6. The reduced-pressure heat treatment jig according to claim 1, wherein the film is disposed on approximately an entire surface of the jig.

7. The reduced-pressure heat treatment jig according to claim 1, wherein the heat treatment is a reduced-pressure carburization treatment.

8. The reduced-pressure heat treatment jig according to claim 1, wherein a reduced-pressure state of the heat treatment is in a range of 0.001 to 0.1 bars.

9. The reduced-pressure heat treatment jig according to claim 1, wherein the workpiece is a ring gear having an approximately cylinder-shaped ring section and formed with spline teeth on an outer circumference surface or an inner circumference surface of the ring section.

10. A reduced-pressure heat treatment method, comprising:
supporting a workpiece of iron by the reduced-pressure heat treatment jig according to claim 1 when the workpiece is subjected to heat treatment in a reduced-pressure atmosphere in which pressure is reduced compared to atmospheric pressure.
